(19) United States
(12) Patent Application Publication
(10) Pub. No.: US 2026/0158406 A1
(43) Pub. Date: Jun. 11, 2026

(54) EVAPORATOR FOR SOLAR-DRIVEN DESALINATION, METHOD FOR MANUFACTURING THE SAME, AND HYBRID DESALINATION SYSTEM INCLUDING THE SAME

(71) Applicant: UIF (University Industry Foundation), Yonsei University, Seoul (KR)

(72) Inventors: Junghwan KIM, Seoul (KR); Jeonghun KIM, Seoul (KR); Sunwoo KIM, Seoul (KR); Jieun JANG, Seoul (KR)

(73) Assignee: UIF (University Industry Foundation), Yonsei University, Seoul (KR)

(21) Appl. No.: 19/410,632

(22) Filed: Dec. 5, 2025

(30) Foreign Application Priority Data
Dec. 6, 2024 (KR) 10-2024-0180771
Nov. 17, 2025 (KR) 10-2025-0173822

(51) Int. Cl. B01D 1/00; B01D 61/00; B01D 61/02; B01D 61/08; B01D 61/58; B29C 39/00; B29C 39/02; B29C 39/42; B29K 105/00; B29K 105/04; B29K 105/12; B29K 105/16; B29K 401/00; B29K 507/04; B29L 31/00; C02F 1/14; C02F 1/44; C02F 9/00; C02F 103/08; F24S 10/80; F24S 80/00

(52) U.S. Cl. CPC B01D 1/0035; B01D 61/0022; B01D 61/08; B01D 61/58; B29C 39/003; B29C 39/02; B29C 39/42; C02F 9/00; F24S 10/80; F24S 80/00; B01D 61/005; B01D 61/025; B01D 2311/08; B01D 2313/246; B29K 2105/005; B29K 2105/04; B29K 2105/124; B29K 2105/167; B29K 2401/00; B29K 2507/04; B29L 2031/779; C02F 1/14; C02F 1/441; C02F 1/445; C02F 2103/08; C02F 2303/10; F24S 2080/014

(57) ABSTRACT

The present invention relates to an evaporator for solar-driven desalination, a method for manufacturing the same, and a hybrid desalination system including the same. More specifically, the evaporator for solar-driven desalination of the present invention includes commercially available and cost-effective carbon nanotubes, cellulose nanofibers, and agarose, and by mixing them at an optimized ratio to prepare an aerogel and applying it as an evaporator for solar-driven desalination, it can have excellent surface hydrophilicity, low density, and very high salt removal efficiency by generating high capillary force with a plurality of vertical microchannels. Furthermore, it is energy-efficient because it has low thermal conductivity, making it efficient for thermal concentration, and can convert sustainable solar energy into thermal energy to recover fresh water without energy consumption. Furthermore, the hybrid desalination system of the present invention can improve fresh water recovery rate and energy generation by forming an SWRO-SD-PRO system in which a seawater desalination unit (SWRO) for fresh water recovery, a solar-driven desalination unit (SD) for additional fresh water recovery, and a pressure retarded osmosis unit (PRO) for energy generation are sequentially combined, and has the advantages of being eco-friendly and economically superior.

### CROSS-REFERENCE TO RELATED APPLICATIONS

This application claims priority to Korean Patent Application Nos. 10-2024-0180771 and 10-2025-0173822, filed on Dec. 6, 2024 and Nov. 17, 2025, respectively and all the benefits accruing therefrom under 35 U.S.C. § 119, the contents of which in its entirety are herein incorporated by reference.

### BACKGROUND

### 1. Field

The present invention relates to an evaporator for solar-driven desalination, a method for manufacturing the same, and a hybrid desalination system including the same.

### 2. Description of Related Art

Water shortage is a serious global problem due to population growth and rapid climate change. One of the main solutions to this problem is desalination technology, which utilizes seawater, which accounts for over 97% of the earth's water. Seawater reverse osmosis (SWRO) is a method using membrane separation, which has relatively low energy consumption and easy scalability compared to traditional thermal desalination methods, and is widely used in more than 90% of desalination facilities worldwide. However, SWRO is still an energy-intensive process requiring high pressures of 50 to 70 bar, and fresh water recovery efficiency is only 40˜50%.

To solve the energy-intensive problem of SWRO, SWRO-pressure retarded osmosis (Pressure retarded osmosis, PRO) hybrid desalination systems are being tested at pilot scale. PRO is a membrane process that generates energy using the flow rate and pressure of water, where a high-salinity solution (draw solution) and a low-salinity solution (feed solution) are mixed, causing water to move from the feed solution to the draw solution due to the salinity difference. Subsequently, optimal pressure is applied to the draw solution after the PRO process to generate energy using a turbine. Research is actively underway to reduce overall energy consumption by utilizing the SWRO brine as the draw solution in SWRO-PRO hybrid systems.

In the prior art, mathematical modeling has been studied to analyze the specific energy consumption (SEC) of the SWRO-PRO hybrid system. When a fresh water recovery efficiency of 50% was achieved in SWRO, the SEC of the SWRO stand-alone system was 2.27 kWh/m3, and it decreased by almost 50% to 1.14 kWh/m3 in the SWRO-PRO hybrid system. In other studies, process parameters were optimized to minimize the SEC of the SWRO-PRO hybrid system. Operating condition variables such as SWRO pressure, PRO pressure, and PRO feed solution concentration were derived, verifying that the SEC was reduced by up to 41% compared to the SWRO stand-alone system. In yet another study, as a result of operating a plant for more than 2 years in the South Sea of Korea to demonstrate the feasibility of the SWRO-PRO hybrid system, it was verified that the SWRO-PRO hybrid system can be operated stably for a long period, and the SEC can be reduced by about 20% compared to the SWRO stand-alone system.

Through these studies, it was successfully verified that the SWRO-PRO hybrid system is practically feasible and can reduce energy consumption. However, the SWRO-PRO hybrid system still had challenges in terms of fresh water recovery and energy generation efficiency. First, the problem of low fresh water recovery still existed. Although fresh water recovery improves as SWRO pressure increases, due to membrane stability and electricity cost issues, the pressure cannot be increased indefinitely. Therefore, the fresh water recovery rate is limited to 40˜50% for economic feasibility. Second, the energy generated in PRO was still low. Due to the low fresh water recovery in SWRO, relatively low salinity brine is used as the draw solution for PRO, resulting in a low salinity difference between the draw solution and the feed solution, leading to poor energy generation in PRO.

### REFERENCE

1. Korean Patent Publication No. 2016-0054230

### SUMMARY

In order to solve the above problems, an object of the present invention is to provide an evaporator for solar-driven desalination including an aerogel having high salt removal efficiency.

Another object of the present invention is to provide a hybrid desalination system including the evaporator for solar-driven desalination of the present invention.

Another object of the present invention is to provide a method for manufacturing an evaporator for solar-driven desalination.

The present invention provides an evaporator for solar-driven desalination, comprising: an aerogel including carbon nanotubes, cellulose nanofibers, and agarose.

The present invention also provides a hybrid desalination system comprising: a seawater reverse osmosis desalination unit for desalting pretreated seawater by reverse osmosis to discharge first fresh water and first concentrated water; a solar-driven desalination unit for desalting the first concentrated water by evaporation using solar heat as an energy source to discharge second fresh water and second concentrated water; and a pressure retarded osmosis unit for producing energy by pressure retarded osmosis using the second concentrated water as a draw solution and utilizing a concentration difference with a feed solution; wherein the solar-driven desalination unit includes the evaporator for solar-driven desalination of the present invention.

The present invention also provides a method for manufacturing an evaporator for solar-driven desalination, comprising: a step of preparing a mixture by mixing carbon nanotubes and cellulose nanofibers; a step of preparing a hydrogel by adding agarose to the mixture and then heating; and a step of preparing an aerogel by pouring the hydrogel into a mold, subjecting it to freeze-casting in a vertical orientation, and then freeze-drying. The method for manufacturing an evaporator for solar-driven desalination is provided.

The evaporator for solar-driven desalination of the present invention includes commercially available and cost-effective carbon nanotubes, cellulose nanofibers, and agarose, and by mixing them at an optimized ratio to prepare an aerogel and applying it as an evaporator for solar-driven desalination, it can have excellent surface hydrophilicity, low density, and very high salt removal efficiency by generating high capillary force with a plurality of vertical microchannels. Furthermore, it is energy-efficient because it has low thermal conductivity, making it efficient for thermal concentration, and can convert sustainable solar energy into thermal energy to recover fresh water without energy consumption.

Furthermore, the hybrid desalination system of the present invention can improve both fresh water recovery rate and energy generation by forming an SWRO-SD-PRO system in which a seawater desalination unit (SWRO) for fresh water recovery, a solar-driven desalination unit (SD) for additional fresh water recovery, and a pressure retarded osmosis unit (PRO) for energy generation are sequentially combined, and has the advantages of being eco-friendly and economically superior.

The effects of the present invention are not limited to the effects mentioned above. It should be understood that the effects of the present invention include all effects derivable from the following description.

### BRIEF DESCRIPTION OF THE DRAWINGS

FIGS. 1A to 1B are water evaporation mechanism (a) of the evaporator for solar-driven desalination including the aerogel according to the present invention and a schematic diagram (b) of the SWRO-SD-PRO hybrid desalination system.

FIGS. 2A to 2B are flow chart (a) of the SWRO-SD-PRO hybrid desalination system according to the present invention and a schematic diagram (b) of the SD condensation system applying the SD evaporator.

FIGS. 3A to 3C are schematic diagram (a) of the MWCNT/CNF/agarose aerogel manufacturing method, (b) (i) a photograph of the MWCNT/CNF/agarose hydrogel before the freeze-drying process, (ii) a photograph of the MWCNT/CNF/agarose aerogel after the freeze-drying process, (iii-vi) SEM images of the MWCNT/CNF/agarose aerogel having many vertically aligned microchannels for absorbing water, and (c) an IR image of the MWCNT/CNF/agarose aerogel surface for observing a temperature gradient, according to example 1 of the present invention.

FIG. 4 is a graph showing the mass change of water over time for the aerogels prepared in example 1 and comparative examples 1 and 2 of the present invention.

FIGS. 5A to 5C show (a) a water evaporation rate performance graph at various NaCl concentrations (SWRO pressure: 30 to 70 bar), (b) a graph of NaCl concentration change before and after SD at various SWRO pressures, and (c) photographs of the SWRO brine concentration process using the MWCNT/CNF/agarose aerogel at various SWRO pressures, regarding the SD evaporator utilizing the aerogel of example 1 of the present invention.

FIGS. 6A to 6C are graph comparing the total fresh water recovery (a), economic analysis (b), and energy generation (c) for the hybrid desalination system (SWRO-SD-PRO) of the present invention and the existing SWRO system and SWRO-PRO system.

### DETAILED DESCRIPTION

Hereinafter, the present invention will be described in more detail with one example.

In the present invention, “brine” means concentrated water (or concentrated salt water) remaining without evaporating during the desalination process of seawater.

The present invention relates to an evaporator for solar-driven desalination, a method for manufacturing the same, and a hybrid desalination system including the same.

As explained above, the existing SWRO-PRO hybrid system still had fresh water recovery and energy generation efficiency challenges remaining. First, although fresh water recovery improves as SWRO pressure increases, the pressure cannot be increased indefinitely due to membrane stability and electricity cost issues, so the fresh water recovery rate was low, limited to 40˜50% for economic feasibility. Second, due to the low fresh water recovery in SWRO, relatively low salinity brine is used as the draw solution for PRO, resulting in a low salinity difference between the draw solution and the feed solution, leading to poor energy generation in PRO.

Therefore, the present invention includes commercially available and cost-effective carbon nanotubes, cellulose nanofibers, and agarose, and by mixing them at an optimized ratio to prepare an aerogel and applying it as an evaporator for solar-driven desalination, it can have excellent surface hydrophilicity, low density, and very high salt removal efficiency by generating high capillary force with a plurality of vertical microchannels. Furthermore, it is energy-efficient because it has low thermal conductivity, making it efficient for thermal concentration, and can convert sustainable solar energy into thermal energy to recover fresh water without energy consumption.

Specifically, the present invention provides an evaporator for solar-driven desalination, comprising: an aerogel including carbon nanotubes, cellulose nanofibers, and agarose.

The carbon nanotubes can serve to provide an efficient path that maximizes solar absorption as a carbon-based material, and specific examples may be one or more selected from the group consisting of multi-walled carbon nanotubes, single-walled carbon nanotubes, and double-walled carbon nanotubes, and preferably may be multi-walled carbon nanotubes. In particular, the multi-walled carbon nanotubes have an excellent advantage as a material for seawater desalination due to their superior light absorption characteristics.

The cellulose nanofibers are an eco-friendly biomass and have excellent mechanical strength, and can form a main skeleton by combining well with other materials. Furthermore, they can serve to further increase salt removal efficiency by having hydrophilicity and high salt resistance characteristics. The cellulose nanofibers may have a diameter of 10 to 100 nm and an average fiber length of 5 to 30 μm, preferably a diameter of 10 to 70 nm and an average fiber length of 10 to 30 μm, and most preferably a diameter of 15 to 50 nm and an average fiber length of 15 to 20 μm.

If the diameter of the cellulose nanofibers is less than 10 nm, or the average fiber length is less than 5 μm, the service life of the aerogel may be shortened due to reduced mechanical strength and heat resistance, and conversely, if the diameter is more than 100 nm, or the average fiber length is more than 30 μm, the internal thermal conductivity and light transmittance may be inhibited.

The agarose may be mixed with the carbon nanotubes and cellulose nanofibers and function to form a water transport path by growing a plurality of vertical microchannels inside the aerogel during the freeze-drying process. The agarose can be dispersed and mixed at a temperature of 90° C., allowing the aerogel to be formed by a simple method.

The aerogel may be mixed such that the multi-walled carbon nanotubes:cellulosenanofibers:agarose are mixed at a weight ratio of 1:1.5-3:15-25, preferably 1:1.7-2.5:17-23, more preferably 1:1.9-2.2:18-22, and most preferably 1:1.9-2.2:20.

In particular, if the content of the cellulose nanofibers is less than 1.5 parts by weight, the surface hydrophilicity and salt resistance characteristics of the aerogel are significantly lowered, so that the salt content in the seawater may not be sufficiently removed, and conversely, if it is more than 3 parts by weight, the size of the vertical microchannels and micropores inside the aerogel may be reduced, thereby lowering the water transport rate.

The aerogel includes vertical microchannels and micropores, generating high capillary force, resulting in very excellent salt removal efficiency.

The aerogel may include a plurality of vertical microchannels and micropores, which are water transport paths, and the vertical microchannels and micropores induce high capillary force, resulting in very excellent salt removal efficiency.

The average pore size of the micropores may be 10 to 150 μm, preferably 20 to 100 μm, and most preferably 30 to 80 μm. In this case, if the average pore size is less than 10 μm, water transport is not smooth, which may take a long time for desalination, and conversely, if it is more than 150 μm, the water transport rate increases, but the capillary force is relatively much weaker, which may result in poor salt removal efficiency.

In particular, for the aerogel according to the present invention, aerogels were manufactured under various conditions and applied to an evaporator for solar-driven desalination to evaluate the fresh water evaporation performance for seawater desalination, durability, and operational stability of the aerogel by conventional methods.

As a result, when the carbon nanotubes are multi-walled carbon nanotubes, and the aerogel includes a plurality of vertical microchannels and micropores having an average pore size of 30-80 μm, salt crystals do not adhere at all to the aerogel surface and inside the vertical microchannels even during continuous desalination operation for 72 hours or more, whereas otherwise, salt accumulation may begin within 24-48 hours, so that satisfying the above conditions is preferable in terms of long-term salt-free accumulation effect.

Further, when the carbon nanotubes are multi-walled carbon nanotubes, the CNF diameter is 15-50 nm, the weight ratio of MWCNT:CNF:agarose is 1:1.9-2.2:18-22, and the aerogel has an average pore size of 30-80 μm, a non-linear synergistic effect is exhibited in which the fresh water evaporation rate additionally increases by 35-42% compared to the simple additive effect, and simultaneously the capillary force improves by 2.8-3.5 times compared to a single material, whereas otherwise, this non-linear synergistic effect may not be exhibited, so satisfying the above conditions is preferable in terms of this non-linear synergistic effect.

Further, only when the conditions that the CNF diameter is in the range of 15-50 nm and the average pore size of the aerogel is 30-80 μm are simultaneously satisfied, the mechanical strain of the aerogel is maintained within 5% despite the change in brine concentration (3.5-20 wt %), and the vertical microchannel structure is preserved without damage for 72 hours or more, whereas otherwise, this critical structural stability effect may not be exhibited, so satisfying the above conditions is preferable in this respect.

Further, when the carbon nanotubes are multi-walled carbon nanotubes, MWCNT:CNF:agarose are mixed at a weight ratio of 1:1.9-2.2:18-22, and the average pore size of the aerogel is 30-80 μm, a dual mechanism operates wherein the surface solar absorption rate is achieved to be 96% or more, and simultaneously heat loss to the bulk aqueous solution is suppressed to 15% or less, so that the photothermal conversion efficiency reaches 92% or more, whereas otherwise, this Dual-mechanism Thermal Management effect may not be exhibited, so satisfying the above conditions is preferable in this respect.

Further, particularly when the carbon nanotubes are multi-walled carbon nanotubes, the cellulose nanofibers have a diameter of 15-50 nm and an average fiber length of 15-20 μm, and the aerogel is mixed such that multi-walled carbon nanotubes:cellulosenanofibers:agarose are at a weight ratio of 1:1.9-2.2:18-22, and the aerogel includes a plurality of vertical microchannels and micropores having an average pore size of 30-80 μm, the fresh water evaporation performance remains high for a long time, the durability of the aerogel is excellent, and the operational stability of the aerogel is very excellent because salt crystals do not adhere at all inside the plurality of microchannels even when desalination continues for a long time, and further, the back diffusion rate of salt ions exceeds a threshold value (Diffusion Flux>Evaporation Flux×1.3), activating inter-channel ion exchange through sidewall pores in the vertical microchannels, causing salt to spontaneously redisperse into the bulk solution, whereas otherwise, not only may the fresh water evaporation performance, aerogel, and operational stability be degraded, but also the above-mentioned Threshold Salt Diffusion effect may not be exhibited, so satisfying the above conditions is highly preferable in this respect.

The present invention also provides a hybrid desalination system comprising: a seawater reverse osmosis desalination unit for desalting pretreated seawater by reverse osmosis to discharge first fresh water and first concentrated water; a solar-driven desalination unit for desalting the first concentrated water by evaporation using solar heat as an energy source to discharge second fresh water and second concentrated water; and a pressure retarded osmosis unit for producing energy by pressure retarded osmosis using the second concentrated water as a draw solution and utilizing a concentration difference with a feed solution; wherein the solar-driven desalination unit includes the evaporator for solar-driven desalination of the present invention.

The existing seawater reverse osmosis (SWRO)-pressure retarded osmosis (PRO) hybrid desalination system is actively being researched in the direction of reducing energy consumption by generating energy in PRO, but the SWRO-PRO hybrid system still had problems such as low fresh water recovery rate and energy generation. To solve these problems, the hybrid desalination system according to the present invention can increase the fresh water recovery rate by forming a hybrid system in which a seawater desalination unit (SWRO) for fresh water recovery, a solar-driven desalination unit (SD) for additional fresh water recovery, and a unit for energy generation are sequentially combined, and the brine recovered from SD can be used as the draw solution for PRO to increase the water flux in PRO due to the increased salinity as fresh water recovery increases, thereby improving energy generation.

The seawater reverse osmosis desalination unit (SWRO) can desalinate the pretreated seawater by reverse osmosis through a semipermeable SWRO membrane to discharge first fresh water from which salt has been removed and highly concentrated first concentrated water. The discharged first concentrated water enters the solar-driven desalination unit (SD) to produce additional fresh water.

The solar-driven desalination unit (SD) can absorb sustainable solar energy, convert it into thermal energy, remove salt from seawater, and produce additional fresh water. That is, an evaporator that absorbs solar energy and rapidly evaporates water floats on the SD, thereby discharging additional second fresh water and second concentrated water.

The pressure retarded osmosis unit (PRO) uses the second concentrated water as a draw solution, and produces energy by pressure retarded osmosis using a concentration difference with a feed solution, and may further include a first energy recovery unit which is located in parallel with the seawater reverse osmosis desalination unit, connected to the solar-driven desalination unit, into which pretreated seawater and the first concentrated water flow in, and in which the pretreated seawater recovers the pressure of the first concentrated water. After the pressure of the first concentrated water is recovered by the pretreated seawater by the efficiency of the first energy recovery device (ERD), it is further compressed to the SWRO operating pressure through a booster pump (BP).

It may further include a second energy recovery unit which is located in parallel with the pressure retarded osmosis unit, connected to the solar-driven desalination unit, into which the second concentrated water flows in, and in which the second concentrated water recovers the pressure of the third concentrated water discharged from the pressure retarded osmosis unit. The second concentrated water enters the second energy recovery unit (ERD) and exchanges pressure with the third concentrated water discharged from the pressure retarded osmosis unit, thereby recovering the pressure of the second concentrated water before flowing into PRO through a booster pump (BP).

After PRO, the water flow fluxed from the feed solution is used to generate energy through a turbine. Subsequently, the remaining water (discharge water) flow is used in the ERD for pressure recovery of the SD brine (second concentrated water).

The seawater reverse osmosis desalination unit is optimized using literature values, the solar-driven desalination unit is optimized by experimental examples, and the pressure retarded osmosis unit can model and optimize the entire system through mathematical modeling.

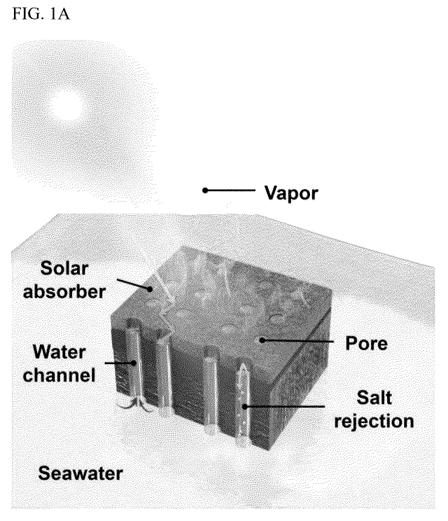

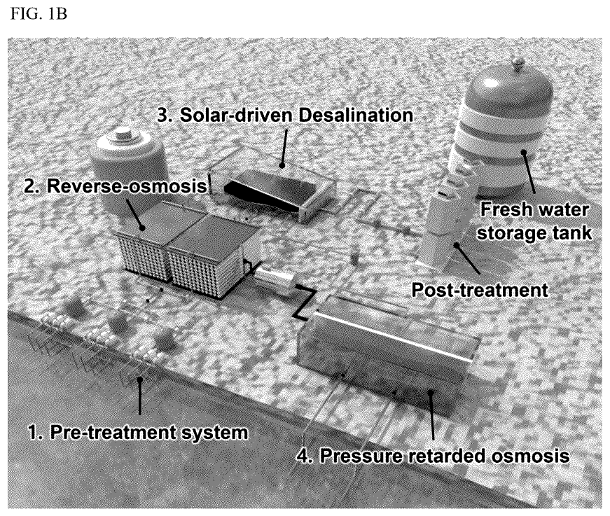

FIGS. 1A to 1B are water evaporation mechanism (a) of the evaporator for solar-driven desalination including the aerogel according to the present invention and a schematic diagram (b) of the SWRO-SD-PRO hybrid desalination system.

Referring to FIG. 1A, the evaporator for solar-driven desalination includes an aerogel manufactured using materials that are commercially mass-producible and inexpensive, having the advantage of excellent universality and economic feasibility.

Referring to FIG. 1B, the SWRO-SD-PRO hybrid desalination system includes both a seawater desalination unit (SWRO), a solar-driven desalination unit (Solar-driven desalination, SD), and a pressure retarded osmosis unit (PRO), and by forming a hybrid desalination system in which they are sequentially combined, it can maximize economic potential and simultaneously optimize operating conditions by modeling based on SWRO literature data, SD experimental results, and a PRO mathematical model, and has excellent energy-efficient and environmental advantages.

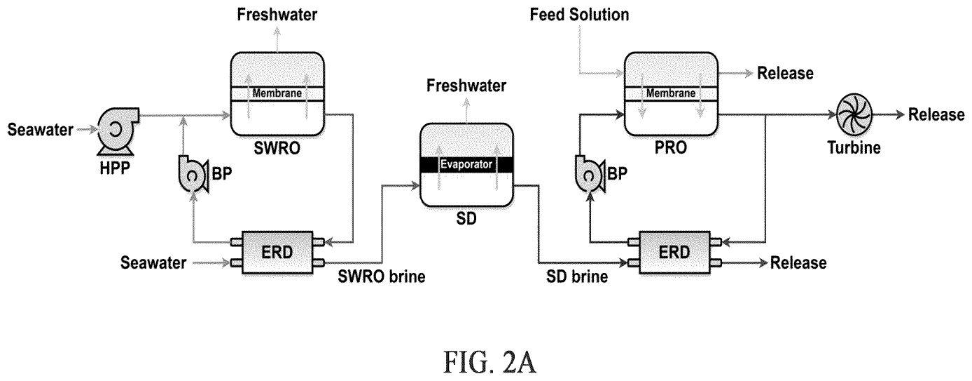

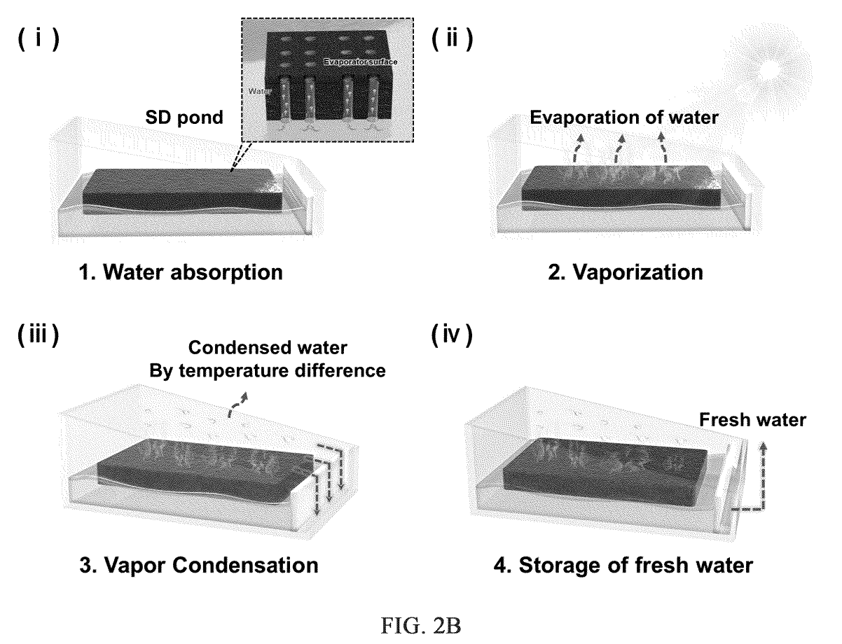

FIGS. 2A to 2B are flow chart (a) of the SWRO-SD-PRO hybrid desalination system according to the present invention and a schematic diagram (b) of the SD condensation system applying the SD evaporator.

In FIG. 2A, the SWRO-SD-PRO hybrid desalination system mainly consists of three stages: (1) a fresh water recovery step in SWRO, (2) a fresh water recovery step in SD, and (3) an energy generation step in PRO. Specifically, first, seawater undergoes a pretreatment process with a capacity of 25,142 m3/day. Thereafter, seawater compressed to the SWRO operating pressure using a high-pressure pump (HPP) enters the SWRO membrane. The compressed seawater passes through the semipermeable membrane to generate first fresh water from which salt has been removed, and the remaining SWRO brine (first concentrated water) enters the first energy recovery unit (ERD). The pressure of the SWRO brine is recovered by the pretreated seawater by the efficiency of the first ERD, and then further compressed to the SWRO operating pressure through a booster pump (BP).

FIG. 2B shows that the SD condensation system mainly consists of (i) a water absorption step of the SD evaporator, (ii) an evaporation step of the absorbed water, (iii) a steam condensation step due to a temperature difference, and (iv) a step of storing the condensed water as fresh water.

FIG. 2B shows that the SWRO brine that has passed through the first ERD enters an SD pond covered with a transparent glass container. The SD evaporator floats on the SWRO brine and rapidly evaporates fresh water using solar energy. When sunlight shines, the SD evaporator converts solar energy into heat, transforming the SWRO brine into second fresh water by evaporation. The evaporated second fresh water is condensed by a transparent glass cover, as shown in FIG. 2B.

In short, the SD evaporator induces capillary force through vertical microchannels to absorb the SWRO brine in the SD pond. The absorbed SWRO brine is exposed to sunlight and evaporates through the surface of the SD evaporator. The SD evaporator has high selectivity in removing salt ions by pumping water in the vertical channels. Therefore, salt ions in the SWRO brine can be removed by the evaporator. Finally, the condensed second fresh water is obtained by separating it from the SWRO brine along the inclined cover.

Furthermore, the highly concentrated SD brine (second concentrated water) that has not evaporated in the SD evaporator enters the second energy recovery unit (ERD) and exchanges pressure, and after the pressure of the second concentrated water is recovered, it flows into PRO through a booster pump (BP). The SD brine (second concentrated water) is used as a draw solution for energy generation in PRO. The draw solution is compressed to the optimal PRO operating pressure, and a feed solution of 1 g/L NaCl is injected at 1 bar. A solution is injected. In the present invention, wastewater discharge may be considered as a source of the feed solution. The salinity difference causes the feed solution to generate water flux toward the draw solution through the semipermeable membrane. After PRO, the water flow fluxed from the feed solution is used to generate energy through a turbine. Subsequently, the remaining water flow is used in the second ERD for pressure recovery of the SD brine (second concentrated water).

The SD evaporator increases the concentration of the draw solution, allowing for much higher water flux in PRO than in existing SWRO-PRO hybrid systems, enabling greater energy generation. Accordingly, the hybrid desalination system of the present invention can increase both fresh water recovery and energy generation.

The present invention also provides a method for manufacturing an evaporator for solar-driven desalination, comprising: a step of preparing a mixture by mixing carbon nanotubes and cellulose nanofibers; a step of preparing a hydrogel by adding agarose to the mixture and then heating; and a step of preparing an aerogel by pouring the hydrogel into a mold, subjecting it to freeze-casting in a vertical orientation, and then freeze-drying. The method for manufacturing an evaporator for solar-driven desalination is provided.

The carbon nanotubes may be one or more selected from the group consisting of multi-walled carbon nanotubes, single-walled carbon nanotubes, and double-walled carbon nanotubes, and preferably may be multi-walled carbon nanotubes.

The cellulose nanofibers may have a diameter of 10 to 100 nm and an average fiber length of 5 to 30 μm, preferably a diameter of 10 to 70 nm and an average fiber length of 10 to 30 μm, and most preferably a diameter of 15 to 50 nm and an average fiber length of 15 to 20 μm.

In the step of preparing the hydrogel, heating may be performed at 90 to 120° C. for 30 seconds to 3 minutes, and preferably at 95 to 110° C. for 1 minute to 2 minutes.

The aerogel may be mixed such that the multi-walled carbon nanotubes:cellulosenanofibers:agarose are at a weight ratio of 1:1.5-3:15-25, preferably 1:1.7-2.5:17-23, more preferably 1:1.9-2.2:18-22, and most preferably 1:1.9-2.2:20.

In the step of preparing the aerogel, the vertical microchannels and micropores inside the aerogel can be grown by freeze-casting the hydrogel in a vertical orientation and then freeze-drying. The average pore size of the micropores may be 10 to 150 μm, preferably 20 to 100 μm, and most preferably 30 to 80 μm.

Hereinafter, the present invention will be described in more detail based on examples, but the present invention is not limited by the following examples.

### Example 1 and Comparative Examples 1 and 2: Manufacturing of MWCNT/CNF/Agarose Aerogel

### (1) Preparation of CNF Dispersion

Cellulose powder consisting of cotton linter having an average fiber length of 20 μm was mixed with a NaOH solution and stirred at 40° C. Thereafter, DIW was added to terminate the NaOH reaction, and the CNF dispersion was prepared by centrifuging with DIW. At this time, the diameter of the CNF was 50 nm, and the average fiber length was 20 μm.

### (2) Manufacturing of MWCNT/CNF/Agarose Aerogel

MWCNT and CNF dispersion were mixed at a weight ratio of 1:1 (comparative example 1), 1:2 (example 1), and 1:4 (comparative example 2), and then dispersed in DIW using tip sonication treatment to prepare a well-dispersed MWCNT/CNF mixture. Thereafter, an agarose polymer for preparing an aerogel was added to the dispersed MWCNT/CNF mixture and heated at 100° C. for 1 minute to quickly dissolve the agarose and prepare a hydrogel. The MWCNT/CNF/agarose hydrogel was heated, stirred for 5 minutes, and poured into a glass mold. Subsequently, MWCNT/CNF/agarose aerogel was obtained by freeze-casting in a vertical orientation in the mold under liquid nitrogen, followed by freeze-drying.

### Experimental Example 1: SEM Analysis

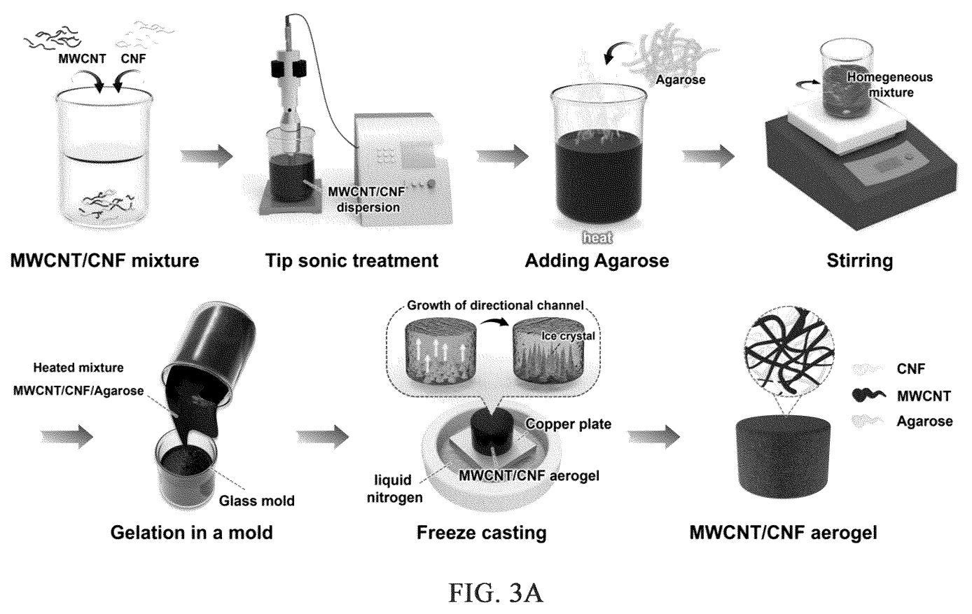

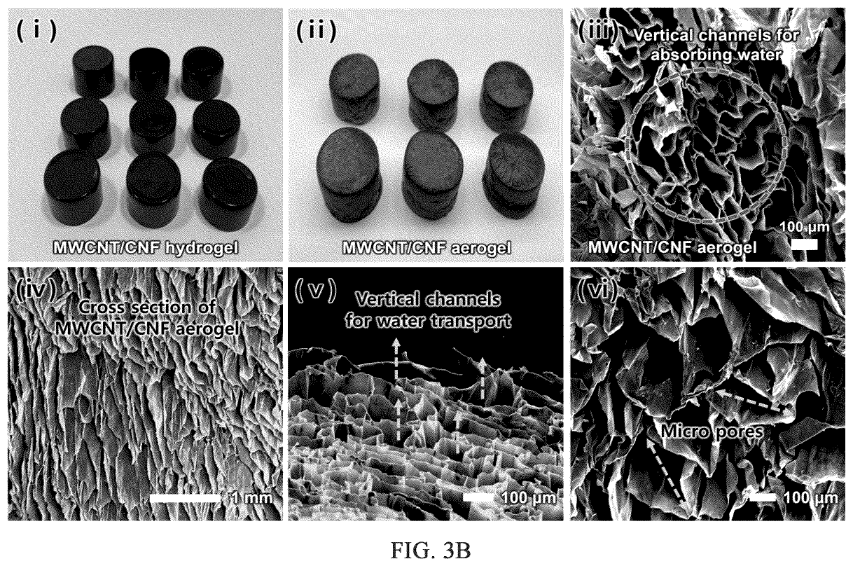

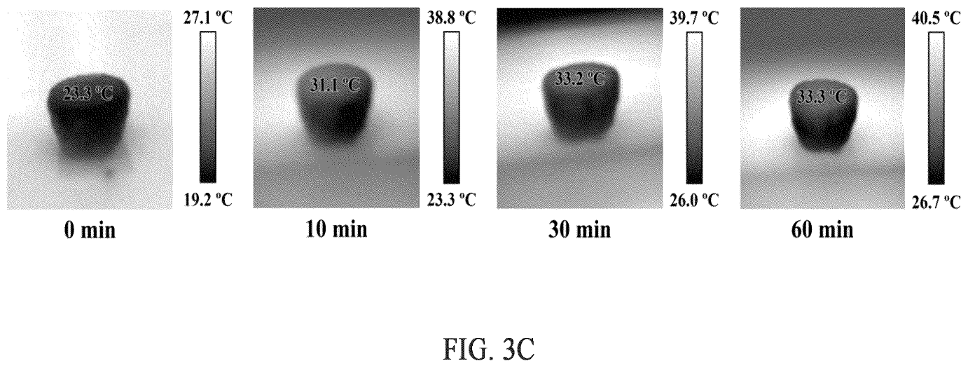

SEM analysis was performed to check the change in microchannels before and after freeze-drying for the SD evaporator using the aerogel prepared in example 1, and the results are shown in FIGS. 3A to 3C.

FIGS. 3A to 3C show (a) schematic diagram of the MWCNT/CNF/agarose aerogel manufacturing method, (b) (i) a photograph of the MWCNT/CNF/agarose hydrogel before the freeze-drying process, (ii) a photograph of the MWCNT/CNF/agarose aerogel after the freeze-drying process, (iii-vi) SEM images of the MWCNT/CNF/agarose aerogel having many vertically aligned microchannels for absorbing water, and (c) an IR image of the MWCNT/CNF/agarose aerogel surface for observing a temperature gradient, according to example 1.

FIG. 3A shows a process of preparing a mixture by mixing carbon nanotubes and cellulose nanofibers, then adding agarose to the mixture and heating to form a hydrogel. Subsequently, the process of manufacturing the MWCNT/CNF/agarose aerogel by pouring the hydrogel into a mold, subjecting it to freeze-casting in a vertical orientation, and then freeze-drying is shown.

FIG. 3B is an SEM image of the MWCNT/CNF/agarose aerogel to confirm the microchannel structure of the SD evaporator, showing that the MWCNT/CNF/agarose aerogel forms a plurality of vertical microchannels through the ice templating process of freeze-drying, and can effectively absorb water due to the formed vertical microchannels. At this time, the average pore size of the vertical microchannels was 55 μm.

The IR image of FIG. 3C shows the surface of the moist MWCNT/CNF/agarose aerogel under solar radiation, confirming that the surface temperature increases and then remains constant as 10 minutes, 30 minutes, and 60 minutes respectively elapse.

### Experimental Example 2: Water Evaporation Rate Performance Analysis

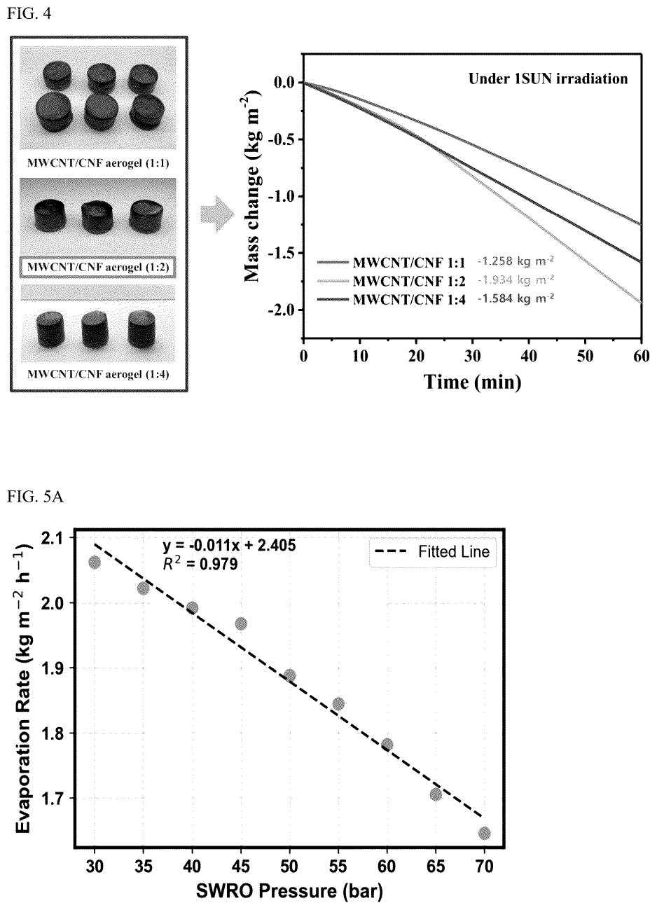

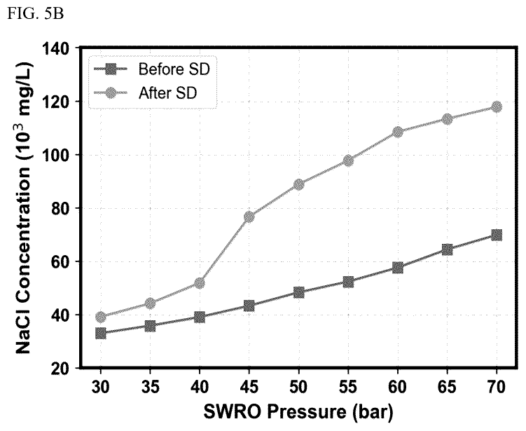

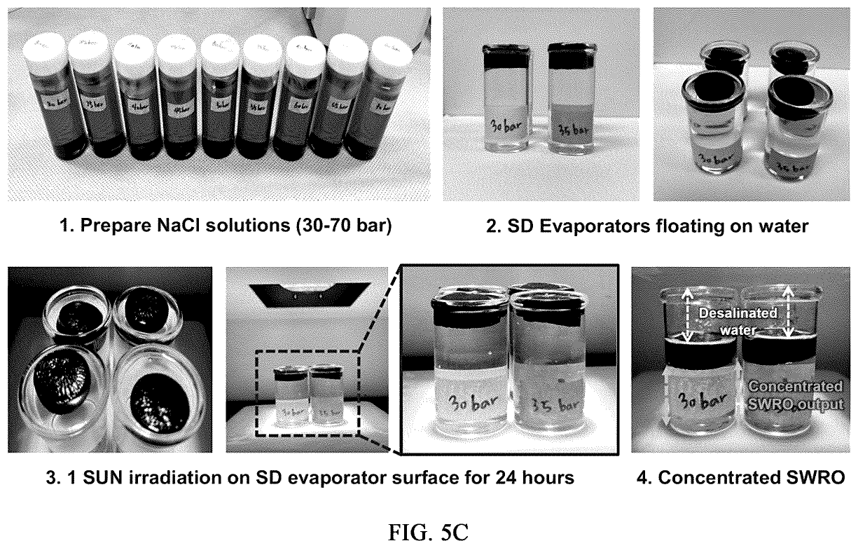

In order to confirm whether the aerogels prepared in example 1 and comparative examples 1 and 2 are suitable for application as an evaporator for solar-driven desalination, the mass change over time, the evaporation rate of SWRO brine for 24 hours per day at various SWRO pressures (30-70 bar), and the water evaporation rate performance were confirmed, and the results are shown in FIGS. 4 and 5 and Table 1.

FIG. 4 is a graph showing the mass change of water over time for the aerogels prepared in example 1 and comparative examples 1 and 2.

Referring to FIG. 4, in the case of example 1, the mass change decreased to 1.934 kg/m2 h, which was the highest value, as water evaporated, whereas comparative examples 1 and 2 showed low mass change values of 1.258 kg/m2 h and 1.584 kg/m2 h, respectively. Through this, it was confirmed that the aerogel of example 1 is most suitable for application as an SD evaporator.

FIGS. 5A to 5B show (a) water evaporation rate performance graph at various NaCl concentrations (SWRO pressure: 30 to 70 bar), (b) a graph of NaCl concentration change before and after SD at various SWRO pressures, and (c) photographs of the SWRO brine concentration process using the MWCNT/CNF/agarose aerogel at various SWRO pressures, regarding the SD evaporator utilizing the aerogel of example 1.

Referring to FIG. 5A, regarding the water evaporation rate performance, examining the results at various SWRO pressures (30 to 70 bar), the water evaporation rate decreased from 2.062 kg/m2 h to 1.646 kg/m2 h as the SWRO pressure increased. Accordingly, it was confirmed that the evaporation rate can be fitted as a function of the SWRO pressure and applied to the entire system modeling.

FIG. 5B shows the SWRO brine concentration before and after SD, and the results showed that the SD brine (after SD) concentration increases as the SWRO brine (before SD) concentration increases. This is shown in Table 1 below.

TABLE 1

| | Concentration of | Concentration of |
|---|---|---|
| SWRO pressure | SWRO brine before | SWRO brine after |
| (bar) | the SD (NaCl mg/L) | the SD (NaCl mg/L) |
| 30 | 33,001 | 39,162 |
| 35 | 35,825 | 44,193 |
| 40 | 39,049 | 51,849 |
| 45 | 43,276 | 76,628 |
| 50 | 48,301 | 88,809 |
| 55 | 52,326 | 97,690 |
| 60 | 57,551 | 108,432 |
| 65 | 64,376 | 113,311 |
| 70 | 69,800 | 117,760 |

According to the results of Table 1, it was found that the SWRO brine concentration after the SD evaporator increased significantly more due to water evaporation compared to the SWRO brine concentration before the SD evaporator. In particular, the brine concentration significantly increased at SWRO pressures of 45 to 70 bar, and it was found that this result is because the amount of water evaporated is similar over the same time, but the higher the SWRO pressure, the higher the concentration of the brine.

FIG. 5C shows the SWRO brine concentration process using the MWCNT/CNF/agarose aerogel at various SWRO pressures. When the MWCNT/CNF/agarose aerogel was used as an SD evaporator at 30 bar and 35 bar, initially the SD evaporator was floating on the water, and after 24 hours of SUN irradiation on the surface of the SD evaporator, the SD evaporator moved to the middle, and the upper side shows the amount of evaporated water that can be converted to desalinated water.

### Experimental Example 3: Optimization Analysis of Hybrid Desalination System

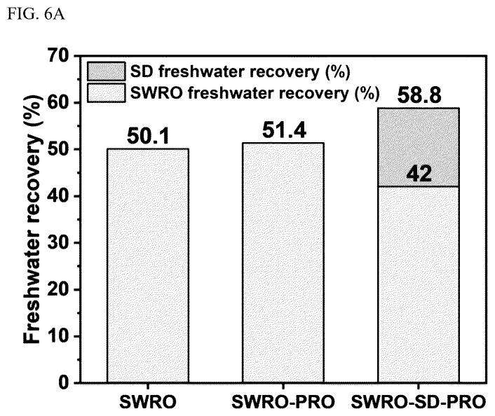

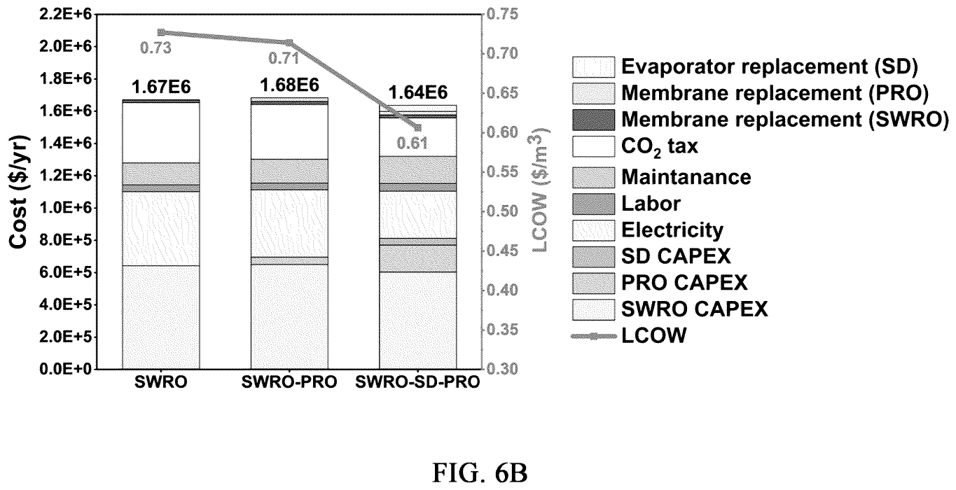

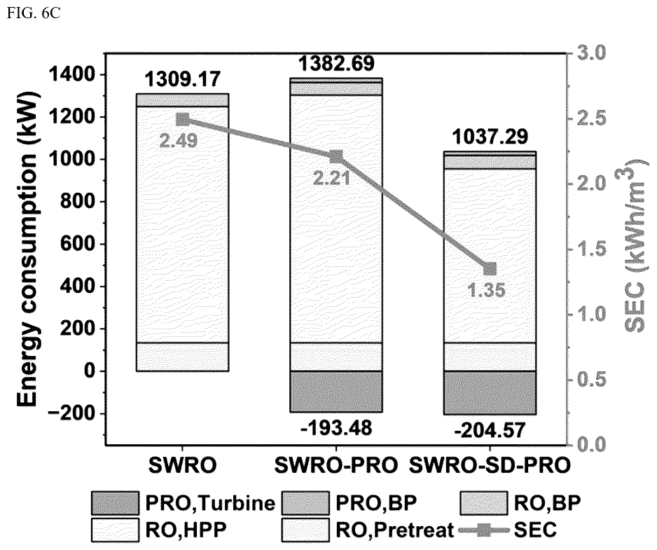

The fresh water recovery rate, energy generation, and economic feasibility of the hybrid desalination system (SWRO-SD-PRO) of the present invention, the SWRO system, and the SWRO-PRO system were analyzed by conventional methods, and the results are shown in FIGS. 6A to 6C.

FIGS. 6A to 6C are graph comparing the total fresh water recovery (a), economic analysis (b), and energy generation (c) for the hybrid desalination system (SWRO-SD-PRO) of the present invention and the existing SWRO system and SWRO-PRO system.

Referring to FIG. 6A, the SWRO fresh water recovery rate of the hybrid desalination system was lower compared to the existing system as the pressure decreased. However, the total fresh water recovery increased due to the fresh water additionally recovered through the SD evaporator.

This indicated that recovering fresh water in SD without energy while reducing the SWRO fresh water recovery rate is cost-effective. Consequently, the total fresh water recovery of the proposed system increased by 17.46% compared to SWRO and by 14.54% compared to SWRO-PRO.

Referring to FIG. 6B, the optimal LCOW of the SWRO-SD-PRO system was 15.15% lower than SWRO-PRO and 16.67% lower than SWRO. In the SWRO-SD-PRO system, the total cost decreased despite additional costs associated with the SD evaporator (evaporator, reservoir, cover, land, and replacement costs). This was confirmed to be because the decrease in SWRO pressure reduces electricity consumption, which also reduces CO2 taxes. Electricity costs and related CO2 taxes account for a large proportion of the total cost, indicating sensitivity to energy consumption. Accordingly, the hybrid desalination system (SWRO-SD-PRO)) of the present invention is highly feasible economically due to the fresh water recovery in the SD evaporator without energy and high energy generation in PRO.

Referring to FIG. 6C, when the optimal SEC (specific energy consumption) of the SWRO-SD-PRO system was compared with SWRO-PRO and SWRO, the SWRO pressure of the SWRO-SD-PRO system was lowered compared to the existing system, thereby reducing energy consumption. Furthermore, the energy generation in the PRO increased by 5.73%, reaching 193.48 kW in SWRO-PRO and 204.57 kW in the SWRO-SD-PRO system. Therefore, the SEC of the SWRO-SD-PRO system decreased by 45.85% compared to SWRO and by 38.86% compared to SWRO-PRO.

As described above, the hybrid desalination system (SWRO-SD-PRO) of the present invention contributed to improving fresh water recovery and reducing costs, and showed potential as a sustainable desalination solution by optimizing energy consumption.

Specifically, the hybrid desalination system according to the present invention introduced the SD evaporator between SWRO and PRO, thereby increasing the total fresh water recovery rate by 14.54%, lowering the LCOW (Average Cost of Water) of fresh water by 15.15%, and reducing the specific energy consumption (SEC) by about 38.86% compared to the existing SWRO-PRO desalination system. Furthermore, although not explicitly described in the experimental examples, the life cycle assessment results considering human health, ecosystem, and resource impact showed that the hybrid desalination system of the present invention is environmentally friendly, confirming its feasibility as a sustainable desalination.

What is claimed is:

1. An evaporator for solar-driven desalination, comprising: an aerogel including carbon nanotubes, cellulose nanofibers, and agarose.

2. The evaporator for solar-driven desalination of claim 1, wherein the carbon nanotubes are one or more selected from the group consisting of multi-walled carbon nanotubes, single-walled carbon nanotubes, and double-walled carbon nanotubes.

3. The evaporator for solar-driven desalination of claim 1, wherein the cellulose nanofibers have a diameter of 10 to 100 nm and an average fiber length of 5 to 30 μm.

4. The evaporator for solar-driven desalination of claim 1, wherein the aerogel is mixed such that the multi-walled carbon nanotubes:thecellulosenanofibers:the agarose are at a weight ratio of 1:1.5-3:15-25.

5. The evaporator for solar-driven desalination of claim 1, wherein the aerogel includes a plurality of vertical microchannels and micropores, and the average pore size of the micropores is 10 to 150 μm.

6. The evaporator for solar-driven desalination of claim 1, wherein the carbon nanotubes are multi-walled carbon nanotubes, and the aerogel includes a plurality of vertical microchannels and micropores having an average pore size of 30-80 μm.

7. The evaporator for solar-driven desalination of claim 1, wherein the carbon nanotubes are multi-walled carbon nanotubes, the diameter of the cellulose nanofibers is 15-50 nm, and the multi-walled carbon nanotubes:the cellulose nanofibers:the agarose are at a weight ratio of 1:1.9-2.2:18-22, and the aerogel has an average pore size of 30-80 μm.

8. The evaporator for solar-driven desalination of claim 1, wherein the carbon nanotubes are multi-walled carbon nanotubes, the multi-walled carbon nanotubes:thecellulosenanofibers:the agarose are mixed at a weight ratio of 1:1.9-2.2:18-22, and the average pore size of the aerogel is 30-80 μm.

9. The evaporator for solar-driven desalination of claim 1, wherein the carbon nanotubes are multi-walled carbon nanotubes, the cellulose nanofibers have a diameter of 15 to 50 nm and an average fiber length of 15 to 20 μm, the aerogel is mixed such that the multi-walled carbon nanotubes:cellulose nanofibers:agarose are at a weight ratio of 1:1.9 to 2.2:18-22, and the aerogel includes a plurality of vertical microchannels and micropores, wherein the average pore size of the micropores is 30 to 80 μm.

10. A hybrid desalination system comprising: a seawater reverse osmosis desalination unit for desalting pretreated seawater by reverse osmosis to discharge first fresh water and first concentrated water; a solar-driven desalination unit for desalting the first concentrated water by evaporation using solar heat as an energy source to discharge second fresh water and second concentrated water; and a pressure retarded osmosis unit for producing energy by pressure retarded osmosis using the second concentrated water as a draw solution and utilizing a concentration difference with a feed solution; wherein the solar-driven desalination unit includes the evaporator for solar-driven desalination of claim 1.

11. The hybrid desalination system of claim 10, further comprising a first energy recovery unit which is located in parallel with the seawater reverse osmosis desalination unit, connected to the solar-driven desalination unit, into which pretreated seawater and the first concentrated water flow in, and in which the pretreated seawater recovers the pressure of the first concentrated water.

12. The hybrid desalination system of claim 10, further comprising a second energy recovery unit which is located in parallel with the pressure retarded osmosis unit, connected to the solar-driven desalination unit, into which the second concentrated water flows in, and in which the second concentrated water recovers the pressure of the third concentrated water discharged from the pressure retarded osmosis unit.

13. A method for manufacturing an evaporator for solar-driven desalination, comprising: a step of preparing a mixture by mixing carbon nanotubes and cellulose nanofibers; a step of preparing a hydrogel by adding agarose to the mixture and then heating; and a step of preparing an aerogel by pouring the hydrogel into a mold, subjecting it to freeze-casting in a vertical orientation, and then freeze-drying.

14. The method for manufacturing an evaporator for solar-driven desalination of claim 13, wherein the carbon nanotubes are one or more selected from the group consisting of multi-walled carbon nanotubes, single-walled carbon nanotubes, and double-walled carbon nanotubes.

15. The method for manufacturing an evaporator for solar-driven desalination of claim 13, wherein the cellulose nanofibers have a diameter of 10 to 100 nm and an average fiber length of 5 to 30 μm.

16. The method for manufacturing an evaporator for solar-driven desalination of claim 13, wherein the heating in the step of preparing the hydrogel is performed at 90 to 120° C. for 30 seconds to 3 minutes.

17. The method for manufacturing an evaporator for solar-driven desalination of claim 13, wherein the aerogel is mixed such that the multi-walled carbon nanotubes:cellulose nanofibers:agarose are at a weight ratio of 1:1.5-3:15-25.

18. The method for manufacturing an evaporator for solar-driven desalination of claim 13, wherein the vertical microchannels and micropores inside the aerogel are grown by freeze-drying in the step of preparing the aerogel.

19. The method for manufacturing an evaporator for solar-driven desalination of claim 18, wherein the aerogel includes a plurality of vertical microchannels and micropores, and the average pore size of the micropores is 10 to 150 μm.
